(19) United States
(12) Patent Application Publication
(10) Pub. No.: US 2023/0411658 A1
(43) Pub. Date: Dec. 21, 2023

(54) SOLID OXIDE FUEL CELL SYSTEM AND STEAM GENERATOR THEREOF

(71) Applicant: Ceres Intellectual Property Company Limited, Horsham, West Sussex (GB)

(72) Inventor: Weilong Song, Weifang, Shandong (CN)

(21) Appl. No.: 18/036,139

(22) PCT Filed: Nov. 11, 2020
(86) PCT No.: PCT/IB2020/060624

§ 371 Date: May 9, 2023

(51) Int. Cl. H01M 8/0612; F22B 1/18; F22B 35/10

(52) U.S. Cl. CPC H01M 8/0631; F22B 1/18; F22B 35/104; H01M 8/0618

(57) ABSTRACT

The invention relates to a solid oxide fuel cell system and a steam generator thereof, wherein the steam generator comprises a water inlet pipe, a casing and a heat exchange device arranged in the casing; a heat exchange cavity is formed between the outer wall of the heat exchange device and the inner wall of the casing, the water inlet pipe communicates with the heat exchange cavity and is used for inputting liquid water into the heat exchange cavity, and the liquid water can exchange heat with the heat exchange device in the heat exchange cavity and form steam; the casing is further provided with a steam exhaust port for exhausting steam in the heat exchange cavity to a reforming device; a steam-water separation grid is arranged on the top wall of a side of the water inlet pipe facing the casing. The continuity and the uniformity of liquid water evaporation can be improved, so that the stability and the reliability of the solid oxide fuel cell system are ensured.

### TECHNICAL FIELD

The present invention relates to the technical field of fuel cells, particularly to a solid oxide fuel cell system and a steam generator.

### BACKGROUND ART

The existing fuel and steam mixing device for a solid oxide fuel cell system adopts a heat exchanger design based on the boiler principle. A plate or shell-and-tube heat exchanger is designed inside a steam generator. Liquid water enters the inside or surface of the heat exchanger via a water inlet device and is heated by a high temperature heat source inside the heat exchanger, or is heated by electricity or fuel until the liquid water boils into steam. The boiling steam is mixed with carbon fuel and enters a reforming device via a gas outlet to undergo a reforming reaction.

Although the boiling heat exchanger based on the boiler principle has a simple structure, due to the uncontrollable principle of boiling heat exchange, steam production and steam pressure fluctuate periodically during the boiling process of liquid water. The periodic fluctuations of steam production and pressure have a great impact on the subsequent uniformity of fuel and steam mixing, continuity of steam reforming reaction and continuity of electrochemical reaction in the stacks. Therefore, improving the continuity and uniformity of liquid water evaporation plays an important role in improving the stability and reliability of the system.

Therefore, how to provide a steam generator that can improve the continuity and uniformity of liquid water evaporation to ensure the stability and reliability of the solid oxide fuel cell system can be a problem.

### SUMMARY OF THE INVENTION

An object of the present invention is to provide a solid oxide fuel cell system and a steam generator thereof, which can improve the continuity and uniformity of liquid water evaporation to ensure the stability and reliability of the solid oxide fuel cell system.

The present invention provides a steam generator of a solid oxide fuel cell system, wherein the steam generator comprises a water inlet pipe, a casing and a heat exchange device arranged in the casing; a heat exchange cavity is formed between the outer wall of the heat exchange device and the inner wall of the casing, the water inlet pipe communicates with the heat exchange cavity and is used for inputting liquid water into the heat exchange cavity, and the liquid water can exchange heat with the heat exchange device in the heat exchange cavity and form steam; the casing is further provided with a steam exhaust port for exhausting steam in the heat exchange cavity to a reforming device; and a steam-water separation grid is arranged on the top wall of a side of the water inlet pipe facing the casing.

The steam-water separation grid is arranged on the top wall of a side of the water inlet pipe facing the heat exchange cavity and is located outside the casing. As the operating ambient temperature of the steam generator is relatively high (about 100° C. to 200° C.), the water in the water inlet pipe may exchange heat with the external environment before input into the heat exchange cavity from a water inlet, thereby generating a part of steam from the liquid water in the water inlet pipe. This part of steam generated in the water inlet pipe will be separated out of the water inlet pipe at the steam-water separation grid when the steam passes through the steam-water separation grid, so that the liquid water in the water inlet pipe maintains a liquid state before entry into the heat exchange cavity to avoid pressure fluctuations at the steam exhaust port due to the unstable airflow in the heat exchange cavity caused by the entry of the gas into the heat exchange cavity, so that the steam generator can continuously and stably provide steam for the reforming device.

In the reforming reaction process, controlling the ratio of carbon fuel to steam and improving the dispersibility of steam and the uniformity of the mixing of steam and carbon fuel play a vital role in raising the efficiency of the system and improving the durability of the stacks. Therefore, continuous and stable provision of steam for the reforming device by the steam generator provided by this embodiment can ensure the stability and reliability of the reforming reaction in the reforming device and the electrochemical reaction in the stacks.

Optionally, the steam generator further comprises a water tank and a circulating steam pipe, the water tank is used for supplying water to the water inlet pipe, and the circulating steam pipe is connected between the water tank and the steam-water separation grid.

Optionally, the steam generator further comprises a first temperature sensor and an on-off valve, and the first temperature sensor is arranged on a side of the water inlet pipe facing the casing; the on-off valve is arranged on the circulating steam pipe and is opened when the temperature detected by the first temperature sensor reaches a preset temperature value, and closed when the temperature detected by the first temperature sensor is lower than the preset temperature value.

Optionally, the side wall of the water inlet pipe is further provided with a thermal insulating layer. The thermal insulating layer can be a thermal insulating cavity arranged on the outer wall of the water inlet pipe and filled with air, argon or carbon dioxide.

Optionally, the water inlet pipe is further provided with a regulating valve, and the steam exhaust port is further provided with a pressure sensor and a second temperature sensor.

Optionally, the steam generator further comprises a water drop device arranged inside the heat exchange cavity, and the water drop device communicates with the water inlet pipe and comprises a plurality of water droppers. The water droppers can be at the same height and evenly spaced.

Optionally, one end of the water inlet pipe in communication with the water drop device is provided with a conical structure, and the thinner end of the conical structure is connected to the water drop device.

The present invention also provides a solid oxide fuel cell system, which comprises a reforming device and the foregoing steam generator.

The technical effect of a solid oxide fuel cell system comprising the foregoing steam generator corresponds to that of the steam generator, and is not described again.

### BRIEF DESCRIPTION OF THE DRAWINGS

FIG. 1 is a structural schematic view of a steam generator of a solid oxide fuel cell system provided by an embodiment of the present invention.

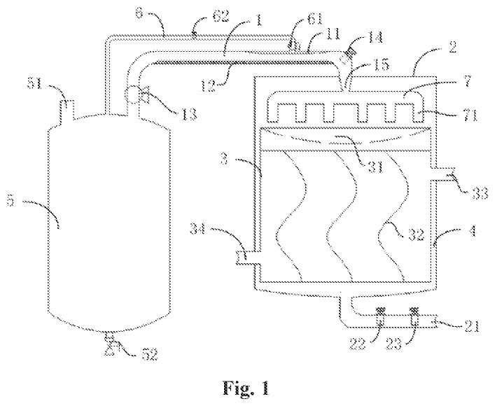

In FIG. 1, the following reference numerals are used: 1-water inlet pipe, 11-steam-water separation grid, 12-thermal insulating layer, 13-regulating valve, 14-first temperature sensor, 15-conical structure. 2-casing, 21-steam exhaust port, 22-pressure sensor, 23-second temperature sensor, 3-heat exchange device, 31-pit, 32-fin, 33-fluid inlet, 34-fluid outlet, 4-heat exchange cavity, 5-water tank, 51-water inlet, 52-water outlet, 6-circulating steam pipe, 61-on-off valve, 62-third temperature sensor, 7-water drop device, 71-water dropper.

### DETAILED DESCRIPTION

The present invention will be further described in detail below with reference to the accompanying drawing and specific embodiments.

FIG. 1 is a structural schematic view of a steam generator of a solid oxide fuel cell system provided by an embodiment of the present invention.

Embodiments of the present invention provide a solid oxide fuel cell system and a steam generator, wherein the solid oxide fuel cell system comprises the steam generator and a reforming device, the steam generator is used for providing steam into the reforming device, the steam and carbon fuel undergo a steam reforming reaction at 300° C. to 800° C. in the reforming device, and the hydrogen and carbon monoxide generated from the steam reforming reaction are input into the stacks of the solid oxide fuel cell system to undergo an electrochemical reaction.

As shown in FIG. 1, the steam generator comprises a water inlet pipe 1, a casing 2 and a heat exchange device 3 arranged in the casing 2. A heat exchange cavity 4 is formed between the outer wall of the heat exchange device 3 and the inner wall of the casing 2. The water inlet pipe 1 communicates with the heat exchange cavity 4. Liquid water can enter the heat exchange cavity 4 from the water inlet pipe 1 and form steam after heat exchange with the heat exchange device 3. The casing 2 is further provided with a steam exhaust port 21 for exhausting steam in the heat exchange cavity 4 to a reforming device.

In other words, the inner wall of the casing 2 and the outer wall of the heat exchange device 3 located inside the casing 2 are enclosed to form the heat exchange cavity 4, and the casing 2 is provided with a water inlet and a steam exhaust port 21 in communication with the heat exchange cavity 4. Here, the water inlet pipe 1 communicates with the water inlet to input external liquid water into the heat exchange cavity 4 via the water inlet and the external liquid water exchanges heat with the heat exchange device 3 inside the heat exchange cavity 4 to form steam, which eventually is exhausted to the reforming device from the steam exhaust port 21.

A steam-water separation grid 11 is arranged on the top wall of a side of the water inlet pipe 1 facing the heat exchange cavity 4 and is located outside the casing 2. As the operating ambient temperature of the steam generator is relatively high (about 100° C. to 200° C.), the liquid water in the water inlet pipe may exchange heat with the external environment before input into the heat exchange cavity 4 via the water inlet, thereby generating a part of steam from the liquid water in the water inlet pipe 1. This part of steam generated in the water inlet pipe 1 will be separated out of the water inlet pipe 1 at the steam-water separation grid 11 when the steam passes through the steam-water separation grid 11, so that the water in the water inlet pipe 1 maintains a liquid state before entry into the heat exchange cavity 4 to avoid pressure fluctuations at the steam exhaust port 21 due to the unstable airflow in the heat exchange cavity 4 caused by the entry of the gas into the heat exchange cavity 4, so that the steam generator can continuously and stably provide steam for the reforming device.

In the reforming reaction process, controlling the ratio of carbon fuel to steam and improving the dispersibility of steam and the uniformity of the mixing of steam and carbon fuel play a vital role in raising the efficiency of the system and improving the durability of the stacks. Therefore, continuous and stable provision of steam for the reforming device by the steam generator provided by this embodiment can ensure the stability and reliability of the reforming reaction in the reforming device and the electrochemical reaction in the stacks.

In this embodiment, the structure of the steam-water separation grid 11 is not limited as long as the steam in the water inlet pipe 1 can be exhausted when the steam passes through the steam-water separation grid 11.

In the foregoing embodiment, the steam generator further comprises a water tank 5 and a circulating steam pipe 6. The water tank 5 is used for supplying water to the water inlet pipe 1, i.e., the water inlet pipe 1 communicates between the water tank 5 and the heat exchange cavity 4 and is used for transporting the water in the water tank 5 into the heat exchange cavity 4, and the circulating steam pipe 6 is connected between the water tank 5 and the steam-water separation grid 11 and used for exhausting the steam in the water inlet pipe 1 to the water tank 5. In other words, in this embodiment, the steam formed in the water inlet pipe 1 can enter the circulating steam pipe 6 from the steam-water separation grid 11, go back to the water tank 5, be condensed in the water tank 5 and re-enter the water inlet pipe 1 as liquid water to achieve water circulation. Such setting can avoid exhausting high temperature steam into the atmosphere and affecting external equipment and meanwhile can also save water. In this embodiment, the water tank 5 is further provided with a water inlet 51 and a water outlet 52, which are used for supplying water to and discharging water from the water tank 5 respectively.

In the foregoing embodiment, the steam generator further comprises a first temperature sensor 14 and an on-off valve 61. The first temperature sensor 14 is arranged on a side of the water inlet pipe 1 facing the casing 2 and is located outside the casing 2. The first temperature sensor 14 is used for detecting the temperature of the liquid water in the water inlet pipe 1 before the liquid water enters the heat exchange cavity 4, and the on-ofi valve 61 is arranged on the circulating steam pipe 6 and is used for controlling the opening and closure of the circulating steam pipe 6. When the temperature detected by the first temperature sensor 14 reaches a preset temperature value, steam can be formed inside the water inlet pipe 1 and the on-off valve 61 is opened so that the steam formed in the water inlet pipe 1 passes through the steam-water separation grid 11 and the circulating steam pipe 6 and is exhausted into the water tank 5. When the temperature detected by the first temperature sensor 14 is lower than the preset temperature value, the liquid water in the water inlet pipe 1 does not form steam and the on-off valve 61 is closed to avoid the liquid water flowing out along the steam-water separation grid 11. The setting of the first temperature sensor and the on-off valve 61 enables selective opening of the steam-water separation grid 11 according to the condition before the liquid water enters the heat exchange cavity 4, and can avoid the liquid water in the water inlet pipe 1 being discharged from there while ensuring the steam in the water inlet pipe 1 can be exhausted, showing desirable flexibility.

When the temperature of the liquid water in the water inlet pipe 1 reaches the preset temperature value, steam will be generated in the water inlet pipe 1, while when the temperature of the liquid water in the water inlet pipe 1 does not reach the preset temperature value, the water in the gas inlet pipe 1 will maintain a liquid state. Specifically, in this embodiment, the specific numerical range of the preset temperature value is not limited, which can be set according to the geographical location of the steam generator and other conditions, or can be summarized according to multiple experiments.

The circulating steam pipe 6 is further provided with a third temperature sensor 62, which is used for detecting the temperature in the circulating steam pipe 6. The setting of the third temperature sensor 62 can be used to calibrate the first temperature sensor 14 and avoid the steam in the water inlet pipe 1 being input into the heat exchange cavity 4 due to breakdown of the first temperature sensor 14.

In the foregoing embodiment, the side wall of the water inlet pipe 1 is further provided with a thermal insulating layer 12. The setting of the thermal insulating layer 12 can reduce heat exchange between the water in the water inlet pipe 1 and the external environment, thereby reducing the amount of steam generated in the water inlet pipe 1 and ensuring the water inlet pipe 1 can continuously and stably input liquid water into the heat exchange cavity 4.

The thermal insulating layer 12 is a thermal insulating cavity arranged on the outer wall of the water inlet pipe 1 and filled with a heat-trapping gas with a low heat conductivity coefficient such as air, argon or carbon dioxide. Alternatively, the thermal insulating layer 12 can be set to be a thermal insulating pad fixedly arranged on the outer wall of the water inlet pipe 1, and there is no specific limitation here. The solution of setting the thermal insulating layer 12 as a thermal insulating cavity filled with a heat-trapping, gas does not need to modify the water inlet pipe 1 itself, and facilitates the arrangement of the thermal insulating layer 12, and at, the same time can make the thermal insulating layer 12 resistant to high temperature and have long service life. Specifically, there are no requirements for the thickness of the thermal insulating layer 12. For example, in this embodiment, the thickness is set to be 0.2 mm. Of course, the thickness can be set at other values, for example, 0.1 to 0.5 mm, or 0.15 to 0.45 mm.

In the foregoing embodiment, the water inlet pipe 1 is further provided with a regulating valve 13, which is used for regulating the flow of the liquid water entering the heat exchange cavity 4 from the water inlet pipe 1. Meanwhile, the steam exhaust port 21 is further provided with a pressure sensor 22 and a second temperature sensor 23. The setting of the pressure sensor 22 and the second temperature sensor 23 is for monitoring the pressure and temperature of the steam exhausted via the steam exhaust port 21 to the reforming device, and determining the exhausting condition of the steam in the heat exchange cavity 4 according to pressure and temperature. Specifically, the opening degree of the regulating valve 13 can be regulated in real time according to the data detected by the pressure sensor 22 and the second temperature sensor 23, the amount of steam needed by the reforming device and other parameters, to control the volume of the liquid water entering the heat exchange cavity 4 from the water inlet pipe 1, maintain stable exhausting of steam from the steam exhaust port 21 and ensure the pressure fluctuations at the steam outlet are stabilized around 4 mbar, at 16 mbar at most.

In the foregoing embodiment, the steam generator further comprises a water drop device 7 arranged in the heat exchange cavity 4, one end of the water drop device 7 communicates with the water inlet pipe 1, and the other end is provided with a plurality of water droppers 71. In other words, in this embodiment, the liquid water in the water inlet pipe 1 is input into the heat exchange cavity 4 by the water drop device 7. Such setting can avoid steam in the water inlet pipe 1 being input into the heat exchange cavity 4 when the steam in the water inlet pipe 1 is too much and is not drained from the steam-water separation grid 11 under extreme conditions. In this case, if the amount of steam input into the heat exchange cavity 4 from the water inlet pipe 1 is large, the input from a plurality of water droppers 71 can reduce the pressure fluctuations in the heat exchange cavity 4 caused by the input steam, thereby reducing the pressure fluctuations at the steam exhaust port 21 and ensuring steam can be uniformly and stably exhausted to the reforming device.

Further, the water droppers 71 are at the same height (i.e., the heights of the water droppers 71 in the heat exchange cavity 4 are consistent) and meanwhile, the water droppers 71 are evenly spaced and are located in the middle area of the heat exchange cavity 4. The middle area of the heat exchange cavity 4 here refers to part of the area extending outward from the center of the transverse section. Such setting can ensure that when liquid water drops into the heat exchange cavity 4 from a plurality of water droppers 71, it can uniformly exchange heat with the heat exchange device 3 and meanwhile, can also cause the steam in the water inlet pipe 1 to be uniformly and stably input into the heat exchange cavity 4, thereby reducing the fluctuations caused by the airflow in the heat exchange cavity 4 and ensuring the stability of the steam in the heat exchange cavity 4.

In the foregoing embodiment, one end of the water inlet pipe 1 in communication with the water drop device 7 is provided with a conical structure 15, and the thinner (i.e. narrower or smaller) end of the conical structure 15 is connected to the water drop device 7. The conical structure 15 forms a throttling structure. Specifically, when the liquid water in the water inlet pipe 1 flows through the conical structure 15, the pressure rises under the same flow due to reduction of the cross section. Meanwhile, the water drop device 7 needs to distribute the liquid water to all water droppers 71 and deliver the liquid water into the heat exchange cavity 4. In other words, after the liquid water with increased pressure enters the water drop device 7 from the conical structure 15, the cross section increases suddenly and the pressure and temperature decrease. Such setting can avoid boiling and generation of steam at the water droppers 71 due to heat exchange between the liquid water in the water droppers 71 and the external heat exchange cavity 4, thereby ensuring that the water dropping from the water droppers 71 into the heat exchange cavity 4 is in a liquid state.

In this embodiment, as shown in FIG. 1, a cavity is provided inside the heat exchange device 3. The cavity is provided with a fluid inlet 33 and a fluid outlet 34 and is for circulation of a heat exchange fluid. Specifically, the heat exchange fluid can be high temperature hot air generated by a combustor of the solid oxide fuel cell system, or a high temperature liquid, or something else, which is not limited here. The heat exchange fluid is used for exchanging heat with the liquid water. The top of the heat exchange device 3 is further provided with a pit 31, which is under the water inlet of the casing 2. The liquid water, which enters the heat exchange cavity 4 from the water inlet pipe 1 (water drop device 7), can exactly drop into the pit 31. Further, some of the liquid water in the pit 31 can form steam, and the remaining liquid water can overflow outwards along the circumference of the pit 31 and flow downwards along the outer wall of the cavity after the liquid water fills up the pit 31. In the process when the liquid water flows downwards along the outer wall of the cavity, the liquid water will exchange heat with the heat exchange fluid in the cavity to form steam.

The heat exchange device 3 in this embodiment is a plate heat exchanger. Of course, there is no limitation to the specific structure of the heat exchange device 3. For example, it can be set to be a tubular heat exchanger, too. The setting of the pit 31 can buffer the liquid water, and when the liquid water in the pit 31 overflows outwards, it can be ensured that the liquid water will be evenly distributed on the surface of the outer sidewall of the cavity and exchange heat sufficiently with the heat exchanger. Further, in this embodiment, the heat exchange device 3 is a cylindrical structure, its upper end face is provided with a round pit 31, and alternatively, the pit 31 can be set in a polygonal structure of its cross section. The shape of the pit 31 can be either regular or irregular as long as the shape of the pit 31 is adaptable with the shape of the cross section of the heat exchange device 3. Specifically, there are no requirements for the size and depth of the pit 31, which can be set according to the size of the cross section of the heat exchange device 3.

Further, a fin 32 is further arranged on the outer sidewall of the cavity to further increase the heat exchange area, ensure the evaporation effect of the liquid water and raise the evaporation efficiency of the liquid water. Alternatively, in this embodiment, the outer sidewall of the cavity can be set to be a radiator fin, or the surface of the outer sidewall of the cavity is set as a corrugated structure, and no limitation is set here.

The above are only preferred implementation manners of the present invention. Various improvements and modifications to the present invention can be made without departing from the principle of the present invention, and within the scope of protection of the present invention.

1. A steam generator of a solid oxide fuel cell system, comprising:
a water inlet pipe;
a casing; and
a heat exchange device arranged in the casing;
wherein:
a heat exchange cavity is formed between the outer wall of the heat exchange device and the inner wall of the casing;
the water inlet pipe communicates with the heat exchange cavity and is used for inputting liquid water into the heat exchange cavity; and
the liquid water can exchange heat with the heat exchange device in the heat exchange cavity and form steam; and
wherein:
the casing is further provided with a steam exhaust port for exhausting steam in the heat exchange cavity to a reforming device; and
a steam-water separation grid is arranged on the top wall of a side of the water inlet pipe facing the casing.

2. The steam generator according to claim 1, comprising:
a water tank; and
a circulating steam pipe,
wherein the water tank is configured to supply water to the water inlet pipe, and the circulating steam pipe is connected between the water tank and the steam-water separation grid.

3. The steam generator according to claim 2, comprising a first temperature sensor and an on-off valve, wherein:
the first temperature sensor is arranged on a side of the water inlet pipe facing the casing; and
the on-off valve is arranged on the circulating steam pipe and is configured to open when the temperature detected by the first temperature sensor reaches a preset temperature value, and close when the temperature detected by the first temperature sensor is lower than the preset temperature value.

4. The steam generator according to claim 1, wherein the side wall of the water inlet pipe is further provided with a thermal insulating layer.

5. The steam generator according to claim 4, wherein the thickness of the thermal insulating layer is 0.1 to 0.5 mm.

6. The steam generator according to claim 5, wherein the thickness of the thermal insulating layer is 0.15 to 0.45 mm.

7. The steam generator according to claim 4, wherein the thermal insulating layer is a thermal insulating cavity arranged on the outer wall of the water inlet pipe and filled with air, argon or carbon dioxide.

8. The steam generator according to claim 1, wherein the water inlet pipe is further provided with a regulating valve, and the steam exhaust port is further provided with a pressure sensor and a second temperature sensor.

9. The steam generator according to claim 1, wherein the steam generator further comprises a water drop device arranged inside the heat exchange cavity, and wherein the water drop device comprises a plurality of water droppers and communicates with the water inlet pipe.

10. The steam generator according to claim 9, wherein the water droppers are located at the same height and are evenly spaced.

11. The steam generator according to claim 9, wherein one end of the water inlet pipe in communication with the water drop device is provided with a conical structure, wherein the smaller end of the conical structure is connected to the water drop device.

12. A solid oxide fuel cell system, comprising a reforming device and the steam generator according to claim 1.
